(19) United States
(12) Patent Application Publication
(10) Pub. No.: US 2026/0044061 A1
(43) Pub. Date: Feb. 12, 2026

(54) ROTATING BODY ATTACHMENT STRUCTURE AND PROJECTION-TYPE IMAGE DISPLAY DEVICE

(71) Applicant: Panasonic Projector & Display Corporation, Osaka (JP)

(72) Inventors: Kohei UEYAMA, Osaka (JP); Atsushi TAKAGI, Osaka (JP); Masato TANAKA, Kyoto (JP)

(21) Appl. No.: 19/360,398

(22) Filed: Oct. 16, 2025

Related U.S. Application Data
(63) Continuation of application No. PCT/JP2024/015127, filed on Apr. 16, 2024.

(30) Foreign Application Priority Data
Apr. 17, 2023 (JP) 2023-067089

(51) Int. Cl. G03B 21/20

(52) U.S. Cl. CPC G03B 21/204

(57) ABSTRACT

A rotating body attachment structure for attaching a rotating body having a hole formed in an attachment surface to a support body having an attachment hole extending through the support body in an axial direction of a rotation axis of the rotating body is provided. The rotating body attachment structure according to the present disclosure includes: an elastic member having a through-hole in the axial direction and configured to be fitted into the attachment hole; and a fixing member including a first portion configured to be inserted into the through-hole in contact with the elastic member, and a front portion configured to be inserted into and fixed in the hole.

### CROSS REFERENCE TO RELATED APPLICATION

This is a continuation application of International Application No. PCT/JP2024/015127 with an international filing date of Apr. 16, 2024, which claims priority of Japanese Patent Application No. 2023-067089 filed on Apr. 17, 2023, the content of which is incorporated herein by reference.

### TECHNICAL FIELD

The present disclosure relates to a rotating body attachment structure for attaching a rotating body. The present disclosure also relates to a rotating body attachment structure for attaching an optical rotating body, such as a phosphor wheel and a color wheel, and a projection-type image display device including the phosphor wheel and/or the color wheel.

### BACKGROUND

Rotating bodies rotated by driving a rotating shaft to rotate are used in rotating devices represented by, for example, a stirrer and a fan. In optical devices, such as a projection-type image display device, an optical rotating body, such as a phosphor wheel or a color wheel is used. A fixing device for mounting these rotating devices is disclosed in JP 2002-89490.

### SUMMARY

In the fixing device disclosed in JP 2002-89490, a rotating body is mounted on a rotating body mounting portion so as to be rotatable about a rotating shaft and to be positioned in the axial direction, and is fixed by tightening nuts. The fixing device is configured to restrain loosening of the nuts for fixation if the rotating body rotates backward, thereby making it possible to secure the fixing force for the rotating body to a sufficient extent.

In a rotating body fixing structure, such as that disclosed in JP 2002-89490, the rotating body is fixed to the rotating body mounting portion in direct contact with screw parts, such as a nut. In such a configuration, vibration of a motor is directly transmitted to the rotating body mounting portion via the screw parts during rotation of the rotating body. Further, such vibration resonates with surrounding mechanical parts to be amplified and cause large noise in some cases. In addition, the optical rotating body, such as a phosphor wheel and a color wheel, used in the projection-type image display device has a challenge to maintain attachment accuracy while suppressing the noise caused by motor vibration.

It is therefore an object of the present disclosure to provide a rotating body attachment structure that can suppress noise caused by vibration during rotation of a rotating body.

In order to address the issue described above, the present disclosure provides a rotating body attachment structure for attaching a rotating body having a hole formed in an attachment surface to a support body having an attachment hole extending through the support body in an axial direction of a rotation axis of the rotating body. The rotating body attachment structure according to one aspect of the present disclosure includes: an elastic member having a through-hole in the axial direction and configured to be fitted into the attachment hole; and a fixing member including a first portion configured to be inserted into the through-hole in contact with the elastic member, and a front portion configured to be inserted into and fixed in the hole.

According to the rotating body attachment structure according to one aspect of the present disclosure, noise caused by vibration during rotation of the rotating body can be suppressed.

### BRIEF DESCRIPTION OF DRAWINGS

FIG. 1 is a block diagram illustrating an overall configuration of a projection-type image display device according to a first embodiment;

FIG. 2 is a schematic view of a light source device in the projection-type image display device in FIG. 1;

FIG. 3 is a view illustrating a configuration example of a light receiving surface of a phosphor wheel in the light source device in FIG. 2;

FIG. 4 is a view illustrating a configuration example of a light receiving surface of a color wheel in the light source device in FIG. 2;

FIG. 5 is a perspective view illustrating attachment of the phosphor wheel;

FIG. 6 is a perspective view illustrating attachment of the color wheel;

FIG. 7 is a side view illustrating the attachment of the phosphor wheel;

FIG. 8 is an exploded perspective view illustrating the attachment of the phosphor wheel using a rotating body attachment structure according to a first example;

FIG. 9A is a cross-sectional view illustrating a configuration of the rotating body attachment structure according to the first example;

FIG. 9B is a cross-sectional view illustrating a configuration of a rotating body attachment structure according to a modification of the first example;

FIG. 10 is a cross-sectional view illustrating a configuration of a rotating body attachment structure according to a second example;

FIG. 11 is a schematic view illustrating a noise measurement layout of a projection-type image display device;

FIG. 12A is a graph illustrating measurement results of noise caused by vibration during rotation of a phosphor wheel; and

FIG. 12B is a graph illustrating measurement results of noise caused by vibration during rotation of a color wheel.

### DETAILED DESCRIPTION

A rotating body attachment structure for attaching a rotating body having a hole formed in an attachment surface to a support body having an attachment hole extending through the support body in an axial direction of a rotation axis of the rotating body. The rotating body attachment structure according to one aspect of the present disclosure includes: an elastic member having a through-hole in the axial direction and configured to be fitted into the attachment hole; and a fixing member including a first portion configured to be inserted into the through-hole in contact with the elastic member, and a front portion configured to be inserted into and fixed in the hole.

According to this aspect, it is possible to provide a rotating body attachment structure that can suppress noise caused by vibration during rotation of the rotating body.

In addition, in a rotating body attachment structure according to another aspect of the present disclosure, the fixing member further includes a rear portion exposed from the through-hole on an opposite side of the attachment surface, the rear portion includes a first wall surface intersecting with the axial direction, and in a state that the front portion is fixed in the hole, the elastic member is compressed between the attachment surface and the first wall surface.

In addition, in a rotating body attachment structure according to another aspect of the present disclosure, the first portion includes a second wall surface intersecting with the axial direction at an end adjacent to the front portion, and in a state that the front portion is fixed in the hole, the second wall surface is in contact with the attachment surface.

In addition, in a rotating body attachment structure according to another aspect of the present disclosure, the hole is a screw hole, the fixing member includes a sleeve and a screw member having a portion inserted into the sleeve, and the sleeve is disposed in contact with the elastic member.

In addition, in a rotating body attachment structure according to another aspect of the present disclosure, the sleeve includes the first portion, and a second portion exposed from the through-hole on the opposite side of the attachment surface, the screw member includes the front portion, and a head portion exposed from the sleeve on the opposite side of the attachment surface, and in a state that the front portion of the screw member is screwed into the screw hole, the second portion of the sleeve defines a first wall surface intersecting with the axial direction, and the elastic member is compressed between the attachment surface and the first wall surface.

In addition, in a rotating body attachment structure according to another aspect of the present disclosure, the sleeve defines the first portion, the screw member includes the front portion, and a head portion exposed from the sleeve on the opposite side of the attachment surface, and in a state that the front portion of the screw member is screwed into the screw hole, the head portion defines a first wall surface intersecting with the axial direction, and the elastic member is compressed between the attachment surface and the first wall surface.

In addition, in a rotating body attachment structure according to another aspect of the present disclosure, in a state that the front portion is screwed into the screw hole, the sleeve is in contact with the attachment surface at the first portion, and in contact with the head portion at the second portion.

In addition, in a rotating body attachment structure according to another aspect of the present disclosure, the hole is a screw hole, the fixing member is integrally formed, the front portion includes screw threads, the first portion has a first cross section that is larger than the front portion in a direction intersecting with the axial direction, and the first wall surface is larger than the first cross section.

In addition, in a rotating body attachment structure according to another aspect of the present disclosure, in a state that the front portion is screwed into the screw hole, the first portion is in contact with the attachment surface at an end adjacent to the front portion.

In addition, in a rotating body attachment structure according to another aspect of the present disclosure, the elastic member includes a recessed section that is formed in an outer peripheral surface in a circumferential direction, and a support member around the attachment hole is fitted into the recessed section.

In addition, in a rotating body attachment structure according to another aspect of the present disclosure, the fixing member is made of a material containing metal.

In addition, in a rotating body attachment structure according to another aspect of the present disclosure, the elastic member is made of a material containing ACM rubber.

In addition, in a rotating body attachment structure according to another aspect of the present disclosure, the rotating body constitutes a phosphor wheel configured to convert incident light into light of a different wavelength, or a color wheel configured to transmits incident light in a plurality of color bands.

In addition, a light source device according to another aspect of the present disclosure includes: a light source configured to output incident light; and a phosphor wheel that is attached by using the rotating body attachment structure according to an aspect of the present disclosure, and configured to convert the incident light into light of a different wavelength, or a color wheel that is attached by using the rotating body attachment structure according to an aspect of the present disclosure, and configured to transmit the incident light in a plurality of color bands.

In addition, a projection-type image display device according to another aspect of the present disclosure includes: the light source device according to an aspect of the present disclosure; a projection light generator configured to generates projection light based on an image signal; a light-guide optical system configured to guide illumination light output from the light source device to the projection light generator; and a projection optical system configured to enlarge and project the projection light from the projection light generator to display an image.

Embodiments of the various embodiments described above are appropriately combined, thereby becoming possible to achieve the respective effects.

Embodiments will hereinafter be described in detail with reference to the drawings as appropriate. However, more detailed description than necessary is omitted in some cases. For example, detailed descriptions of already well-known matters and duplicated descriptions for substantially the same configurations are omitted in some cases. This is intended to avoid unnecessary redundancy of the following description and to facilitate understanding by those skilled in the art.

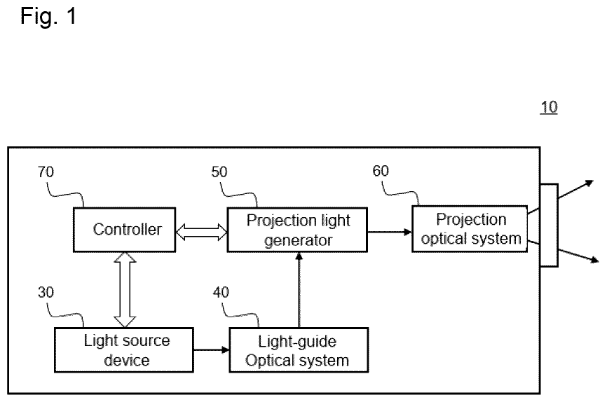

A rotating body attachment structure and a projection-type image display device according to an embodiment of the present disclosure will be described with reference to FIGS. 1 to 12B. The accompanying drawings and the following description are provided so that those skilled in the art can fully understand the present disclosure, and it is not intended to limit the subject matter described in the scope of claims thereby. In addition, each element is exaggerated for clear description in each drawing. In the drawings, substantially the same members are denoted by the same reference signs.

### (Overall Configuration of Projection-Type Image Display Device According to First Embodiment)

A configuration of a projection-type image display device according to a first embodiment will be described with reference to FIG. 1. FIG. 1 is a block diagram illustrating an overall configuration of a projection-type image display device 10 according to the first embodiment.

As illustrated in FIG. 1, the projection-type image display device 10 includes a light source device 30, a light-guide optical system 40, a projection light generator 50, a projection optical system 60, and a controller 70. The projection-type image display device 10 causes the projection light generator 50 to generate projection light corresponding to input image signals, based on light emitted from the light source device 30, and projects projection light generated by the projection optical system 60 onto a projection target, such as an external screen, to display an image.

The light source device 30 includes a solid-state light source, such as a semiconductor laser and a phosphor, and emits light under the control of the controller 70. Specifically, the light source device 30 can include an illumination optical system including a light source and one or both of a phosphor wheel and a color wheel (details will be described later). Details of the configuration of the light source device 30 will be described later.

The light-guide optical system 40 guides light output from the light source device 30 to the projection light generator 50. The light-guide optical system 40 is configured with various optical members, such as various lenses, mirrors, and rods, arranged as appropriate.

The projection light generator 50 includes a light modulation element (not illustrated), such as a digital micromirror device and a liquid crystal panel. In the projection light generator 50, the light modulation element is used to modulate incident light based on the image signal.

The projection optical system 60 guides light output from the projection light generator 50 to a projection lens, and the projection lens enlarges and projects the light from the projection light generator 50 to display an image. The projection optical system 60 is configured with various optical members, such as various lenses and mirrors.

The controller 70 controls the overall operation of the projection-type image display device 10. The controller 70 can include, for example, an input terminal (not illustrated) for inputting external image signals, and various drivers (not illustrated). The various drivers can include, for example, a light source driver, a wheel driver, and a display device driver. The light source driver drives light source in the light source device 30. The wheel driver drives the phosphor wheel or the color wheel included in the light source device 30. The display device driver can supply image signals to the light modulation element in the projection light generator 50 to drive the light modulation element. Various functions of the controller 70 may be incorporated separately in components of the projection-type image display device 10.

### (Configuration of Light Source Device)

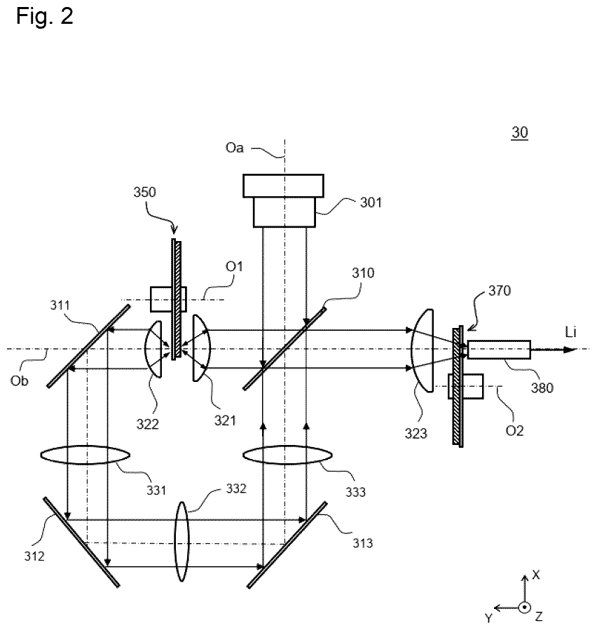

Details of the configuration of the light source device 30 in the projection-type image display device 10 will be described with reference to FIG. 2. FIG. 2 is a schematic view of the light source device 30 in the projection-type image display device 10 in FIG. 1. Hereunder, as an example of the light source device that generates white light from blue light emitted from the light source, the light source device 30 including a phosphor wheel 350 and a color wheel 370 will be described. FIG. 2 illustrates the configuration of the light source device 30 in an X-Y plane.

As illustrated in FIG. 2, the light source device 30 includes a laser light source 301, a dichroic mirror 310, condenser lenses 321, 322, and 323, mirrors 311, 312, and 313, lenses 331, 332, and 333, the phosphor wheel 350, the color wheel 370, and a rod integrator 380.

In the light source device 30, the laser light source 301 outputs blue laser light. The laser light source 301 may include a plurality of semiconductor laser elements. The blue laser light from the laser light source 301 travels along an optical axis Oa to enter the dichroic mirror 310 disposed at an inclination angle of approximately 45 degrees with respect to the optical axis Oa.

The dichroic mirror 310 has a characteristic of reflecting the blue laser light of the laser light source 301 and transmitting light in other wavelength ranges. The blue laser light incident in a −X direction in the figure is reflected by the dichroic mirror 310, is output in a +Y direction in the figure, travels along an optical axis Ob, and is focused by the condenser lens 321 to enter the phosphor wheel 350.

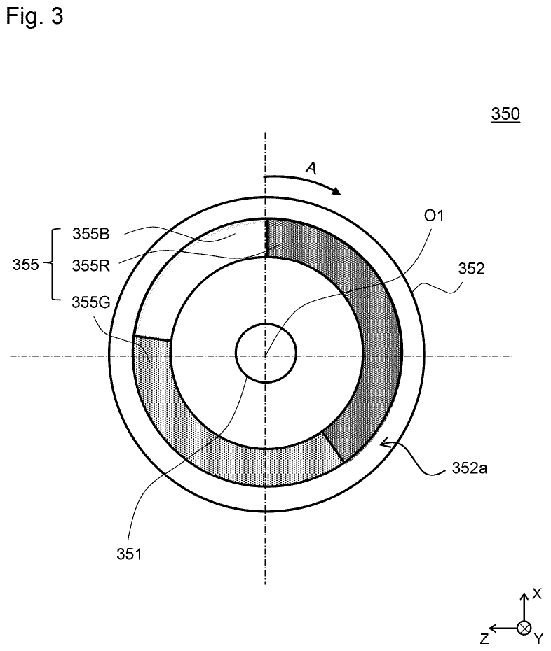

A configuration of the phosphor wheel 350 will be described with reference to FIG. 3. FIG. 3 is a view illustrating a configuration example of a light receiving surface of the phosphor wheel 350 in the light source device 30 in FIG. 2. The phosphor wheel 350 is configured to output, in a time-division manner by rotation, the blue light obtained by transmitting the blue laser light from the laser light source 301 and fluorescent light obtained by converting the wavelength of the blue laser light from the laser light source 301 into different wavelengths.

As illustrated in FIG. 3, the phosphor wheel 350 includes a disk-shaped substrate 352 that is driven to rotate by a motor (not illustrated in FIG. 3) via a shaft 351 located in a central portion. The substrate 352 can rotate about a rotation axis O1 in a rotation direction A illustrated in the figure, around the shaft 351 by the drive of the motor. Rotating the substrate 352 makes it possible to suppress temperature rises of phosphor layers on the substrate 352 due to excitation light, so that to maintain a stable wavelength conversion efficiency.

An annular region 355 is formed on a light receiving surface 352a of the substrate 352 illustrated in FIG. 3, and includes an opening region 355B and a phosphor layer regions 355R and 355G. The opening region 355B transmits the incident blue laser light. In the phosphor layer regions 355R and 355G, phosphor layers that are excited by the incident blue laser light to emit fluorescent light are formed. In the present embodiment, the phosphor layer regions include the red phosphor layer region 355R and the green phosphor layer region 355G that are formed in a circumferential direction. The red phosphor layer region 355R and the green phosphor layer region 355G are excited by the incident blue laser light to emit red fluorescent light and green fluorescent light, respectively.

In the configuration example of the phosphor wheel 350 illustrated in FIG. 3, the annular region 355 is illustrated as having two kinds of the phosphor layer regions; however, the present disclosure is not limited thereto. For example, the annular region 355 of the phosphor wheel 350 can also be configured to include one kind or three or more kinds of phosphor layer regions.

The rotation of the phosphor wheel 350 allows the blue light to be transmitted and output when the blue laser light transmitted through the condenser lens 321 is incident on the opening region 355B, and when the blue laser light is incident on the phosphor layer regions 355R and 355G, allows the phosphors to be excited to emit the red fluorescent light and the green fluorescent light.

Returning to FIG. 2, the red fluorescent light and the green fluorescent light that are generated in the phosphor layer regions 355R and 355G of the phosphor wheel 350 are reflected in a −Y direction from the phosphor wheel 350, pass through the condenser lens 321, and pass through the dichroic mirror 310 to travel along the optical axis Ob. On the other hand, the blue light that passes through the opening region 355B of the phosphor wheel 350 is transmitted through the lens 322, travels along a path of the mirror 311, the lens 331, the mirror 312, the lens 332, the mirror 313, and the lens 333, and is reflected by the dichroic mirror 310 to be output along the optical axis Ob. The blue light, the red fluorescent light, and the green fluorescent light that are output from the dichroic mirror 310 in the −Y direction along the optical axis Ob as described above, are transmitted through the condenser lens 323 and incident on the color wheel 370.

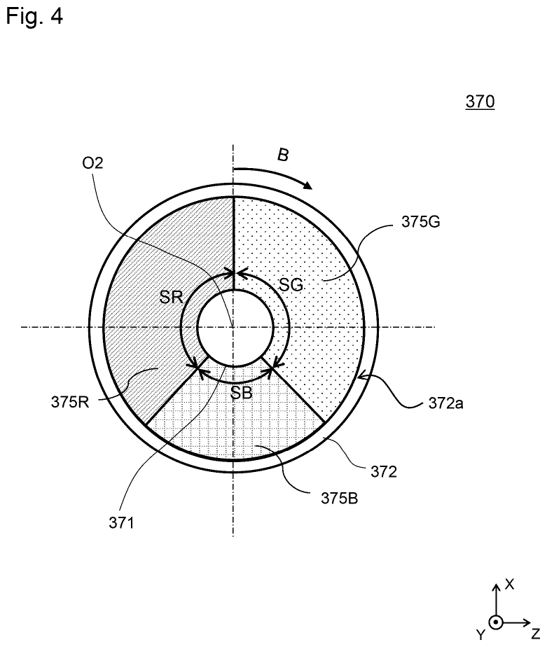

The color wheel 370 is configured to receive, from the phosphor wheel 350, yellow fluorescent light and the blue light that are transmitted through the condenser lens 323, and transmit the light in a plurality of color bands by the rotation to output the transmitted light in a time-division manner. A configuration of the color wheel 370 will be described with reference to FIG. 4. FIG. 4 is a view illustrating a configuration example of a light receiving surface of the color wheel 370 in the light source device 30 in FIG. 2.

As illustrated in FIG. 4, the color wheel 370 includes a disk-shaped transparent substrate 372 that is driven by a motor (not illustrated) and rotates around a shaft 371 located in a central portion. Dichroic layers 375G and 375R and an antireflection layer 375B are formed on a light receiving surface 372a of the transparent substrate 372 illustrated in FIG. 4.

The transparent substrate 372 has three colored light segments SR, SG, and SB in a circumferential direction. In the present embodiment, the colored light segment SB of the color wheel 370 has an angle corresponding to the opening region 355B (see FIG. 3) of the phosphor wheel 350, and the colored light segments SR and SG have angles corresponding to the phosphor layer regions 355R and 355G (see FIG. 3) of the phosphor wheel 350, respectively.

On the light receiving surface 372a of the transparent substrate 372, formed are the dichroic layer 375R that transmits red light with the colored light segment SR, the dichroic layer 375G that transmits green light with the colored light segment SG, and the antireflection layer 375B that transmits blue light being light source light, with the colored light segment SB.

The color wheel 370 is controlled by the controller 70 (see FIG. 1) so as to rotate synchronously with the phosphor wheel 350 about a rotation axis O2 in a rotation direction B. Specifically, the color wheel 370 is controlled such that the dichroic layer 375R is located on the optical axis Ob during a period in which blue laser light incident on the phosphor wheel 350, serving as excitation light, is incident on the phosphor layer region 355R that emits red fluorescent light; the dichroic layer 375G is located on the optical axis Ob during a period in which the blue laser light, serving as excitation light, is incident on the phosphor layer region 355G that emits green fluorescent light; and the antireflection layer 375B is located on the optical axis Ob during a period in which the blue laser light is incident on the opening region 355B. This allows the light in the wavelength ranges of red, green, and blue that are excellent in color purity to be sequentially output and be incident on the rod integrator 380.

The light, incident on the rod integrator 380, in the wavelength ranges of red, green, and blue is reflected a plurality of times inside the rod integrator 380, whereby the light intensity distribution is made uniform and the light is output from the light source device 30 as white illumination light Li.

In the light source device 30 illustrated in FIG. 2, the configuration example including both the phosphor wheel 350 and the color wheel 370 is illustrated; however, the present disclosure is not limited thereto. For example, the light source device 30 can be configured not to include the color wheel 370. The light source device in the projection-type image display device according to the present embodiment can be configured by employing any other light source arrangements known in the art. Detailed description thereof is omitted here.

### (Attachment of Phosphor Wheel or Color Wheel)

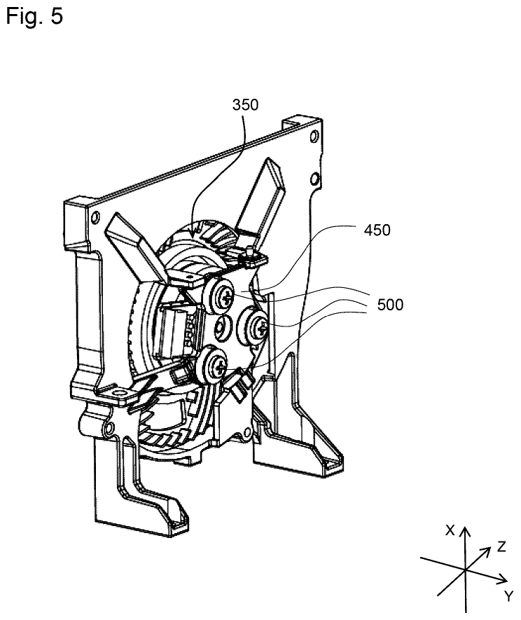

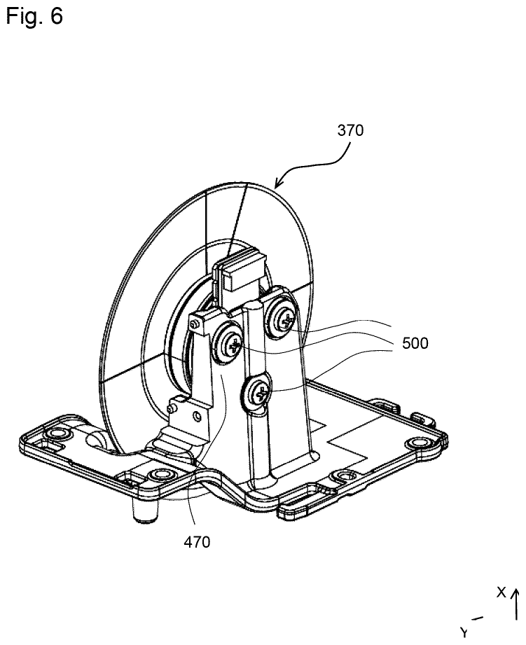

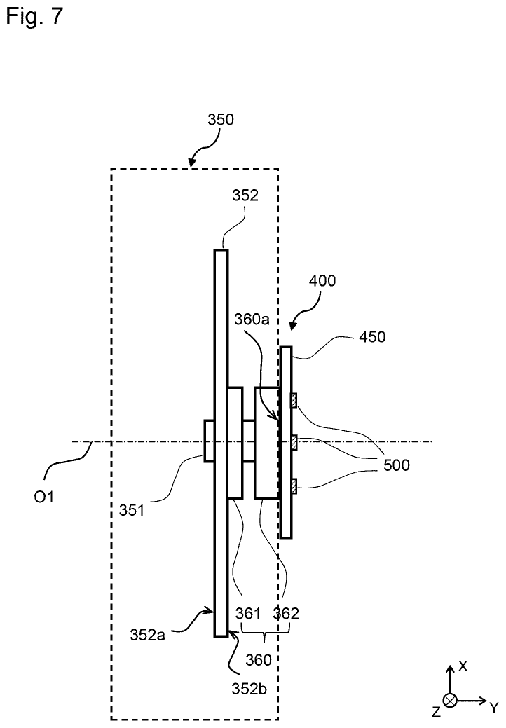

With reference to FIGS. 5 to 7, description will be given of attachment of the phosphor wheel and the color wheel in the light source device of the projection-type image display device according to the present embodiment. FIG. 5 is a perspective view illustrating the attachment of the phosphor wheel 350. FIG. 6 is a perspective view illustrating the attachment of the color wheel 370. FIG. 7 is a side view illustrating the attachment of the phosphor wheel 350.

As illustrated in FIGS. 5 and 6, the phosphor wheel 350 and the color wheel 370 are attached to a support surface 450 of a phosphor wheel holder and a support surface 470 of a color wheel holder, with rotating body attachment structures 500. In the present embodiment, the phosphor wheel 350 or the color wheel 370 is attached using three rotating body attachment structures 500; however, the present disclosure is not limited to the number of the rotating body attachment structures used in the attachment.

While the phosphor wheel 350 is taken as an example, details of a rotational configuration of a rotating body in the projection-type image display device 10 will be described with reference to FIG. 7. As illustrated in FIG. 7, the phosphor wheel 350 includes the substrate 352 and a motor 360. The phosphor wheel 350 is one example of the rotating body in the present embodiment. The color wheel 370 has a rotational configuration substantially similar to that of the phosphor wheel 350, but the transparent substrate 372 (see FIG. 4) is different from the substrate 352 (see FIG. 3) of the phosphor wheel 350 in configuration. Detailed description of the rotational configuration of the color wheel 370 is omitted.

The substrate 352 of the phosphor wheel 350 is, for example, a disk-shaped metal substrate made of a thermally conductive material, such as aluminum. The annular region including the phosphor layer regions is formed on the light receiving surface 352a of the substrate 352 (FIG. 3). The motor 360 is attached to a surface 352b opposite to the light receiving surface 352a of the substrate 352. The substrate 352 defines a rotating surface of the phosphor wheel 350.

In the present embodiment, the motor 360 is configured with a rotor 361 and a stator 362. The rotor 361 is attached to the surface 352b of the substrate 352 in the phosphor wheel 350, and is formed integrally with the rotating surface of the phosphor wheel 350. The stator 362 supports the rotor 361 via the shaft 351. The drive of the motor 360 enables the substrate 352 of the phosphor wheel 350 and the rotor 361 to integrally rotate about the rotation axis O1 around the shaft 351.

The motor 360 is attached on an attachment surface 360a for the stator 362 to the support surface 450 of a phosphor wheel holder 400 that is a support body of the rotating body, using the rotating body attachment structures 500. The rotating body attachment structures 500 allow the phosphor wheel 350 to engage with the phosphor wheel holder 400 and stably rotate, and additionally, makes it possible to achieve precise positioning in a direction of the rotation axis O1, and to suppress noise caused by vibration during operation of the rotating body. Hereunder, a configuration of the rotating body attachment structures 500 of the present disclosure will be described.

### (Rotating Body Attachment Structure)

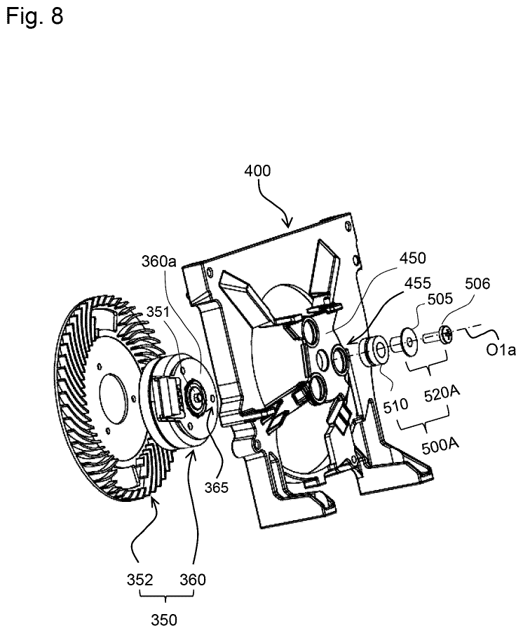

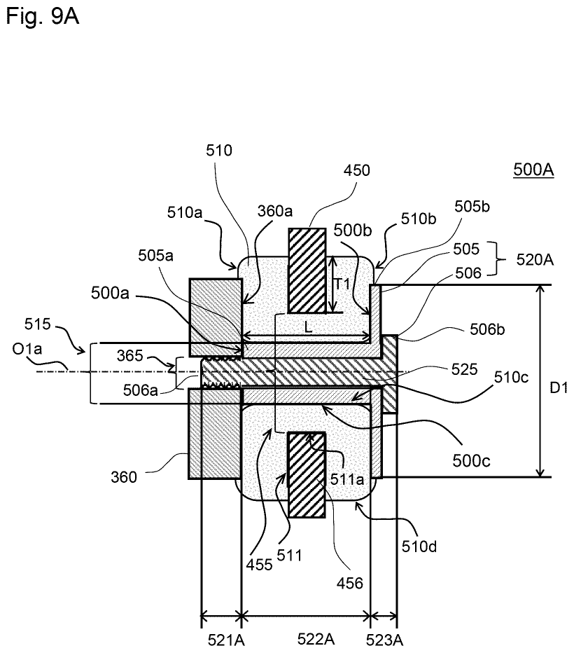

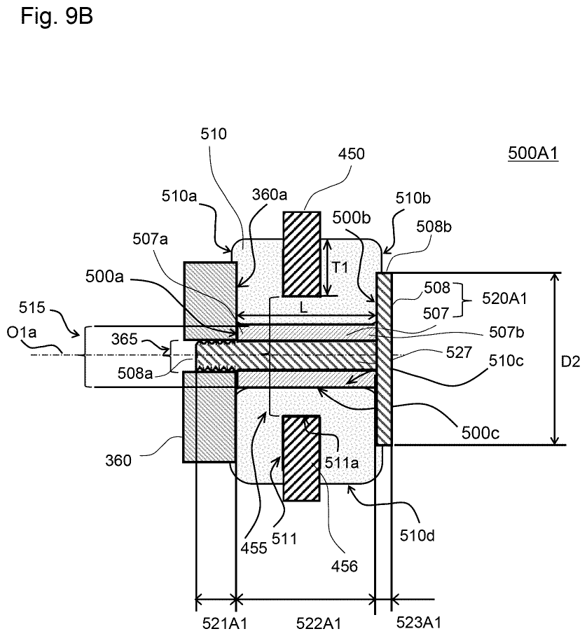

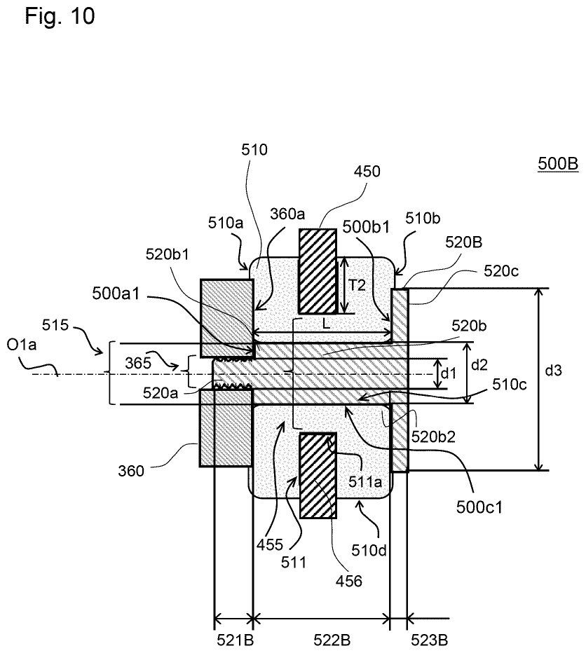

The configuration of the rotating body attachment structures 500 will be described with reference to FIGS. 8 to 10 while the attachment of the phosphor wheel 350 is taken as an example. FIG. 8 is an exploded perspective view illustrating the attachment of the phosphor wheel 350 using a rotating body attachment structure 500A according to a first example. FIG. 9A is a cross-sectional view illustrating a configuration of the rotating body attachment structure 500A according to the first example. FIG. 9B is a cross-sectional view illustrating a configuration of a rotating body attachment structure 500A1 according to a modification of the first example. FIG. 10 is a cross-sectional view illustrating a configuration of a rotating body attachment structure 500B according to a second example.

As illustrated in FIG. 8, the motor 360 of the phosphor wheel 350 has a screw hole 365 formed in the attachment surface 360a, and in the support surface 450 of the phosphor wheel holder 400, an attachment hole 455 is formed. The attachment hole 455 extends through the phosphor wheel holder 400 in a direction of a mounting axis O1a parallel to the rotation axis of the phosphor wheel 350. The rotating body attachment structure 500A is screwed into the screw hole 365 through the attachment hole 455 along the mounting axis O1a to attach the phosphor wheel 350 to the phosphor wheel holder 400.

### (Rotating Body Attachment Structure According to First Example)

The rotating body attachment structure 500A according to the first example includes an elastic member 510 and a fixing member 520A. The fixing member 520A is configured with a sleeve 505 and a screw member 506. As illustrated in FIG. 9A, the elastic member 510 has a through-hole 515 in the direction of the mounting axis O1a, and the fixing member 520A is inserted into the through-hole 515.

The elastic member 510 is fitted into the attachment hole 455 in the support surface 450 of the phosphor wheel holder 400 to be interposed between the attachment surface 360a of the phosphor wheel 350 and the support surface 450 of the phosphor wheel holder 400. This makes it possible to attenuate the vibration during the rotation of the phosphor wheel 350, suppress transmission of the vibration to the phosphor wheel holder 400, and reduce the noise due to the vibration.

The elastic member 510 can be constituted, for example, by a bush made of an elastic material. The elastic material constituting the elastic member 510 can be selected so as to have a sufficiently low transmission coefficient at a frequency of the noise that may be generated by the rotation of the rotating body. In the selection of the elastic material constituting the elastic member 510, for example, an elastic material suitable for an operating environment can be adopted in view of an aspect, such as the operating environment of the rotating body.

In the present embodiment, in the projection-type image display device including the phosphor wheel and the color wheel, noise around 3000 Hz, caused by the rotation speeds of the phosphor wheel and the color wheel is likely to occur due to the vibration during the rotation. Hence, the elastic material constituting the elastic member 510 can be selected such that the transmission coefficient at a noise frequency around 3000 Hz is less than 1. In addition, in the operating environment of the phosphor wheel and the color wheel, such a material can be adopted that has sufficient mechanical strength and heat resistance and that causes relatively little degeneration and degradation as a result of exposure to light. In the present example, for example, the elastic member 510 can be constituted by using a bush made of ACM rubber (acrylic rubber).

As illustrated in FIG. 9A, the through-hole 515 is formed in the elastic member 510 in the direction of the mounting axis O1a, and the fixing member 520A is inserted into the through-hole 515. The fixing member 520A is, for example, a rigid member made of a material containing metal. The fixing member 520A can include, in the direction of the mounting axis O1a, a central portion 522A disposed in the through-hole 515, a front portion 521A exposed from the through-hole 515 on the attachment surface 360a side, and a rear portion 523A exposed from the through-hole 515 on the opposite side of the attachment surface 360a. The front portion 521A of the fixing member 520A is provided with screw threads, and can be screwed into the screw hole 365 in the attachment surface 360a of the motor 360. The central portion 522A and the rear portion 523A of the fixing member 520A include two wall surfaces 500a and 500b that intersect with the direction of the mounting axis O1a. This makes it possible to accurately perform positioning for screwing of the fixing member 520A, and additionally, to form an interposed surface 500c between the attachment surface of the rotating body and the support surface of the support body to provide a space for interposing the elastic member 510.

Specifically, as illustrated in FIG. 9A, the fixing member 520A of the rotating body attachment structure 500A according to the present example is configured with the sleeve 505 and the screw member 506. The sleeve 505 has opposite end sections 505a and 505b, and a through-channel 525 that is formed in the center in the direction of the mounting axis O1a. The end section 505a of the sleeve 505 is insertable into the through-hole 515 of the elastic member 510, while the end section 505b has a large cross section area in the direction intersecting the direction of the mounting axis O1a. The end section 505b is not insertable into the through-hole 515, and is exposed from the through-hole 515. A portion between the opposite end sections 505a and 505b is inserted into the through-hole 515. As described above, in the present example, the opposite end sections 505a and 505b of the sleeve 505 constitute the two wall surfaces 500a and 500b of the fixing member 520A, and the portion, inserted into the through-hole 515, between the opposite end sections 505a and 505b forms the interposed surface 500c. In the present example, the wall surfaces 500a and 500b are configured to be approximately orthogonal to the direction of the mounting axis O1a, while the configuration is not limited thereto.

The screw member 506 includes a front section 506a on which screw threads are formed, and a head section 506b. The front section 506a is inserted into the through-channel 525 from the end section 505b of the sleeve 505, and is exposed from the sleeve 505 on the attachment surface 360a side. The head section 506b is configured to be not insertable into the sleeve 505, and is exposed from the sleeve 505 on the opposite side of the attachment surface 360a. As illustrated in the figure, the screw member 506 can be inserted into the through-channel 525 until the head section 506b is in contact with the end section 505b of the sleeve 505, and at this time, the front section 506a of the screw member 506 protrudes from the end section 505a of the sleeve 505 to be allowed to be screwed into the screw hole 365 in the attachment surface 360a of the motor 360. As described above, in the present example, the front section 506a of the screw member 506 defines the front portion 521A of the fixing member 520A.

In a state in which the front section 506a of the screw member 506 is screwed into the screw hole 365 in the attachment surface 360a, as illustrated in FIG. 9A, the sleeve 505 has the end section 505a in contact with the attachment surface 360a at the wall surface 500a, and the end section 500b in contact with the head section 506b of the screw member 506. At this time, with a length L between the opposite end sections 505a and 505b of the sleeve 505, positioning for screwing of the fixing member 520A can be accurately performed in the direction of the mounting axis O1a of the fixing member 520A.

When an optical rotating body, such as the phosphor wheel and the color wheel, is attached to the support body, it is desirable to attach the optical rotating body to the support surface such that the rotating surface of the rotating body is perpendicular to the rotation axis in order to secure the stability of the rotation and a precise light propagation path. As illustrated in FIGS. 5 and 6, the phosphor wheel 350 and the color wheel 370 are attached to the support surfaces 450 and 470 by using a plurality of the rotating body attachment structures 500. The positioning in the screwing direction achieved by each of the rotating body attachment structures is matched with the others, whereby the rotating surfaces of the phosphor wheel and the color wheel can be attached so as to be perpendicular to the rotation axis. In the present example, the sleeve 505 that is a rigid member is inserted into the elastic member 510 to perform the positioning in the direction of the mounting axis O1a, so that it is possible to avoid issues caused by variations in dimensions due to individual differences of machined parts and suppress variations due to imbalance in tightening force caused during attachment, and to ensure positioning accuracy in the direction of the mounting axis O1a. For example, in the present example, with the length L between the opposite end sections 505a and 505b of the sleeve 505, the phosphor wheel can be attached with high accuracy such that a positioning tolerance falls within ±0.1 mm in the direction of the mounting axis O1a.

As illustrated in FIG. 9A, the space for interposing the elastic member 510 is formed between the attachment surface 360a of the motor 360 and the wall surface 500b of the end section 505b of the sleeve 505. An inner peripheral surface 510c of the through-hole 515 of the elastic member 510 is disposed in contact with the interposed surface 500c formed by the portions of the sleeve 505 inserted into the through-hole 515. A recessed section 511 is formed in an outer peripheral surface 510d of the elastic member 510 in a circumferential direction, and a support member 456 around the attachment hole 455 of the support surface 450 is disposed so as to be fitted into the recessed section 511 of the outer peripheral surface 510d of the elastic member 510. The recessed section 511 can be formed in any shape, and the present disclosure is not limited thereto. For example, the inner surface of the recessed section 511 may be a flat surface or a curved surface.

For example, the elastic member 510 can be configured to have a length that is longer than the length L between the opposite end sections 505a and 505b of the sleeve 505 when a natural state is made between the opposite end surfaces 510a and 510b in the direction of the mounting axis O1a. This allows the elastic member 510 to be compressed between the attachment surface 360a of the motor 360 and the wall surface 500b of the end section 505b of the sleeve in the direction of the mounting axis O1a, in a state in which the front section 506a of the screw member 506 is screwed into the screw hole 365. Thus, the attachment surface 360a of the phosphor wheel 350 and the support surface 450 of the phosphor wheel holder 400 can engage with each other via the elastic member 510 without being in direct contact with each other. This makes it possible to attenuate the vibration during the rotation of the rotating body, suppress the transmission of the vibration to the support body, and reduce the noise due to the vibration.

In the present example, the sleeve 505 can be configured such that the end section 505b has a diameter D1 that is larger than a diameter of the attachment hole 455. This makes it possible to stably engage the attachment surface 360a and the support member 456 by the elastic member 510 that is compressed between the attachment surface 360a and the wall surface 500b of the end section 505b of the sleeve.

The support member 456 can be fitted into the recessed section 511 on the outer peripheral surface 510d of the elastic member 510 at a depth T1. In the present example, for example, the depth T1 can be formed to be about 1 mm. This makes it possible to stably engage the support member 456 and the attachment surface 360a via the elastic member 510. The outer peripheral surface 510d of the elastic member 510 may or may not be in contact with the support member 456 on a bottom surface 511a of the recessed section 511. The present disclosure is not limited thereto.

Further, in a direction orthogonal to the mounting axis O1a, the elastic member 510 can be configured to be in contact with the interposed surface 500c formed by the portions of the sleeve 505 inserted into the through-hole 515, at the inner peripheral surface 510c of the through-hole 515. This makes it possible to attenuate the vibration transmitted through the sleeve during the rotation of the rotating body.

Screw threads may not be formed on the portion inserted into the through-channel 525, between the front section 506a and the head section 506b of the screw member 506, of the sleeve 505. The outer diameter of the screw member 506 and the inner diameter of the through-channel 525 of the sleeve 505 can be designed such that the portion, in the sleeve 505, of the screw member 506 is partially in contact with an inner wall of the through-channel 525, or is closer to each other. This makes it possible to suppress the vibration that may occur due to play of the screw member in the sleeve during the rotation of the rotating body. The use of the sleeve 505 formed of a rigid member makes it possible to avoid issues caused by variations in dimensions due to individual differences of machined parts, and to ensure the accuracy in the design of the outer diameter of the screw member 506 and the inner diameter of the through-channel 525 of the sleeve 505. Alternatively, a configuration may be adopted such that an elastic material layer (not illustrated) is provided in the through-channel 525 of the sleeve 505, and the portion, in the sleeve 505, of the screw member 506 is in contact with the inner wall of the through-channel 525 via the elastic material layer. This makes it possible to further suppress the vibration transmitted by the screw member.

In the first example illustrated in FIG. 9A, the end section 505b of the sleeve 505 defines the wall surface 500b in the direction orthogonal to the mounting axis O1a, and contacts the elastic member 510 with a sufficient area, and thus can provide, together with the attachment surface 360a and the interposed surface 500c, the space in which the elastic member 510 is interposed. However, the wall surface 500b is not limited to being configured by the end section 505b of the sleeve 505. For example, the wall surface 500b can be configured by the head section of the screw member. This description will be given with reference to a modification illustrated in FIG. 9B.

### (Rotating Body Attachment Structure According to Modification of First Example)

The rotating body attachment structure 500A1 according to the modification of the first example illustrated in FIG. 9B includes an elastic member 510 and a fixing member 520A1. The elastic member 510 has the same configuration as the elastic member of the rotating body attachment structure 500A illustrated in FIG. 9A, but the rotating body attachment structure 500A1 differs from the rotating body attachment structure 500A in the configuration of the fixing member 520A1.

The fixing member 520A1 of the rotating body attachment structure 500A1 is configured with a sleeve 507 and a screw member 508. The sleeve 507 has opposite end sections 507a and 507b, and a through-channel 527 that is formed in the center in a direction of a mounting axis O1a. The sleeve 507 has the opposite end sections 507a and 507b having approximately the same shape, and is formed in a substantially cylindrical shape. The entire sleeve 507 is inserted into a through-hole 515 of the elastic member 510 to constitute a central portion 522A1 of the fixing member 520A1 and forms an interposed surface 500c.

As illustrated in FIG. 9B, the screw member 508 of the rotating body attachment structure 500A1 includes a front section 508a on which screw threads are formed, and a head section 508b. The front section 508a is inserted into the through-channel 527 from the end section 507b of the sleeve 507, and is exposed from the sleeve 507 on an attachment surface 360a side. The head section 508b has a large cross section area in a direction intersecting the direction of the mounting axis O1a, is configured to be insertable into the sleeve 507, and is exposed from the sleeve 507 on the opposite side of the attachment surface 360a. As illustrated in the figure, the screw member 508 can be inserted into the through-channel 527 until the head section 508b gets in contact with the end section 507b of the sleeve 507, and at this time, the front section 508a of the screw member 508 protrudes from an end section 507a of the sleeve 507 to be allowed to be screwed into a screw hole 365 in the attachment surface 360a of a motor 360. The head section 508b of the screw member 508 defines a wall surface 500b in a direction orthogonal to the mounting axis O1a, and contacts the elastic member 510 with a sufficient area, and thus can provide, together with the attachment surface 360a and the interposed surface 500c, a space in which the elastic member 510 is interposed.

For example, the elastic member 510 can be configured to have a length that is longer than a length L between the opposite end sections 507a and 507b of the sleeve 507 when a natural state is made between opposite end surfaces 510a and 510b in the direction of the mounting axis O1a. This allows the elastic member 510 to be compressed between the attachment surface 360a of the motor 360 and the head section 508b of the screw member 508 in the direction of the mounting axis O1a, in a state in which the front section 508a of the screw member 508 is screwed into the screw hole 365. Thus, the attachment surface 360a of a phosphor wheel 350 and a support surface 450 of a phosphor wheel holder 400 can engage with each other via the elastic member 510 without being in direct contact with each other. This makes it possible to attenuate the vibration during the rotation of the rotating body, suppress the transmission of the vibration to a support body, and reduce the noise due to the vibration.

In the present example, the screw member 508 can be configured such that the head section 508b has a diameter D2 that is larger than a diameter of the attachment hole 455. This makes it possible to stably engage the attachment surface 360a and a support member 456 by the elastic member 510 that is compressed between the attachment surface 360a and the wall surface 500b of the head section 508b.

Since the other configurations of the rotating body attachment structure 500A1 are similar to those of the rotating body attachment structure 500A illustrated in FIG. 9A, detailed description thereof is omitted.

### (Rotating Body Attachment Structure According to Second Example)

Next, the rotating body attachment structure 500B according to the second example will be described with reference to FIG. 10. The rotating body attachment structure 500B includes an elastic member 510 and a fixing member 520B. The elastic member 510 has the same configuration as the elastic member of the rotating body attachment structure 500A illustrated in FIG. 9A, but the rotating body attachment structure 500B differs from the rotating body attachment structure 500A in the configuration of the fixing member 520B.

The fixing member 520B of the rotating body attachment structure 500B is integrally formed as a single piece, and is inserted into a through-hole 515 of the elastic member 510 as one part. The fixing member 520B is constituted, for example, by a rigid member made of a material containing metal. The fixing member 520B can include, in a direction of a mounting axis O1a, a central portion 522B disposed in the through-hole 515, a front portion 521B on an attachment surface 360a side, and a rear portion 523B that are exposed from the through-hole 515 on the opposite side of the attachment surface 360a. The front portion 521B of the fixing member 520B is provided with screw threads, and can be screwed into a screw hole 365 in the attachment surface 360a of a motor 360. The central portion 522B and the rear portion 523B of the fixing member 520B include two wall surfaces 500al and 500b1 that intersect with the direction of the mounting axis O1a. This makes it possible to accurately perform positioning for screwing of the fixing member 520B in the direction of the mounting axis O1a, and additionally, to form an interposed surface 500c1 between the attachment surface of a rotating body and a support surface of a support body to provide a space for interposing the elastic member 510.

Specifically, as illustrated in FIG. 10, the fixing member 520B of the rotating body attachment structure 500B according to the present example includes a threaded section 520a on which screw threads are formed, a central section 520b with enlarged diameter, and an end wall section 520c. The central section 520b is located between the threaded section 520a and the end wall section 520c, and is configured with a columnar body having an outer diameter d2 that is larger than an outer diameter d1 of the screw threads of the threaded section 520a. The end wall section 520c is configured to have a diameter d3 that is larger than the outer diameter d2 of the central section 520b. The central section 520b has a first end 520b1 adjacent to the threaded section 520a, and a second end 520b2 adjacent to the end wall section 520c, and has a length L between the first end 520b1 and the second end 520b2.

The fixing member 520B integrally formed is inserted into the through-hole 515 of the elastic member 510. The threaded section 520a is screwed into the attachment surface 360a through the through-hole 515 of the elastic member 510. The central section 520b is inserted into the through-hole 515 to form an interposed surface 500c1. The first end 520b1 forms a wall surface 500al adjacent to the threaded section 520a, and the end wall section 520c forms a wall surface 500b1 adjacent to the central section 520b. The wall surface 500b1 has a sufficient area, and can provide a space for interposing the elastic member 510, together with the attachment surface 360a and the interposed surface 500c1. In the present example, the wall surfaces 500al and 500b1 are configured to be approximately orthogonal to the direction of the mounting axis O1a, while the configuration is not limited thereto.

In a state in which the threaded section 520a is screwed into the screw hole 365 in the attachment surface 360a, as illustrated in FIG. 10, the first end 520b1 of the central section 520b adjacent to the threaded section 520a is in contact with the attachment surface 360a at the wall surface 500al, and with the length L of the central section 520b, the positioning for screwing of the fixing member 520B can be accurately performed in the direction of the mounting axis O1a.

As illustrated in FIG. 10, the space for interposing the elastic member 510 is formed between the attachment surface 360a of the motor 360 and the wall surface 500b1 of the end wall section 520c. An inner peripheral surface 510c of the through-hole 515 of the elastic member 510 is disposed in contact with the interposed surface 500c1 formed by the central section 520b inserted into the through-hole 515. A recessed section 511 is formed in an outer peripheral surface 510d of the elastic member 510 in a circumferential direction, and a support member 456 around an attachment hole 455 of a support surface 450 is disposed so as to be fitted into the recessed section 511 of the outer peripheral surface 510d of the elastic member 510. The recessed section 511 can be formed in any shape, and the present disclosure is not limited thereto. For example, the inner surface of the recessed section 511 may be a flat surface or a curved surface.

For example, the elastic member 510 can be configured to have a length that is longer than the length L of the central section 520b when a natural state is made between opposite end surfaces 510a and 510b in the direction of the mounting axis O1a. This allows the elastic member 510 to be compressed between the attachment surface 360a of the motor 360 and the wall surface 500b1 of the end wall section 520c in the direction of the mounting axis O1a, in a state in which the threaded section 520a is screwed into the screw hole 365. Thus, the attachment surface 360a of a phosphor wheel 350 and the support surface 450 of a phosphor wheel holder 400 can engage with each other via the elastic member 510 without being in direct contact with each other. This makes it possible to attenuate the vibration during the rotation of the rotating body, suppress the transmission of the vibration to the support body, and reduce the noise due to the vibration.

In the present example, the fixing member 520B can be configured such that the end wall section 520c has a diameter d3 that is larger than a diameter of the attachment hole 455. This makes it possible to stably engage the attachment surface 360a and the support member 456 by the elastic member 510 that is compressed between the attachment surface 360a and the wall surface 500b1 of the end wall section 520c.

The support member 456 can be fitted into the recessed section 511 on the outer peripheral surface 510d of the elastic member 510 at a depth T2. In the present example, for example, the depth T2 can be formed to be about 1 mm. This makes it possible to stably engage the support member 456 and the attachment surface 360a via the elastic member 510. The outer peripheral surface 510d of the elastic member 510 may or may not be in contact with the support member 456 on a bottom surface 511a of the recessed section 511. The present disclosure is not limited thereto.

Further, the elastic member 510 can be configured to abut, in a direction orthogonal to the mounting axis O1a, on the interposed surface 500cl formed by the central section 520b inserted into the through-hole 515 at the inner peripheral surface 510c of the through-hole 515. This makes it possible to attenuate the vibration transmitted through the fixing member 520B during the rotation of the rotating body.

As described above, with the rotating body attachment structure according to the present disclosure, it is possible to suppress the noise due to the vibration during the rotation of the rotating body and achieve noise diminishment of the device including the rotating body by engaging the attachment surface of the rotating body and the support surface of the support body via the elastic member. It is also possible to accurately perform the positioning for screwing in the axial direction of the rotation axis of the rotating body, attach the optical rotating body such that the rotating surface of the rotating body is perpendicular to the rotation axis, and ensure the stability of the rotation and also a precise light propagation path.

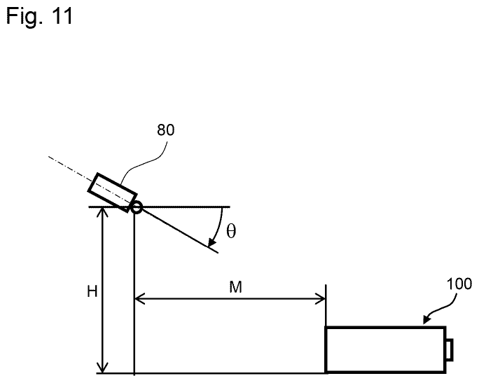

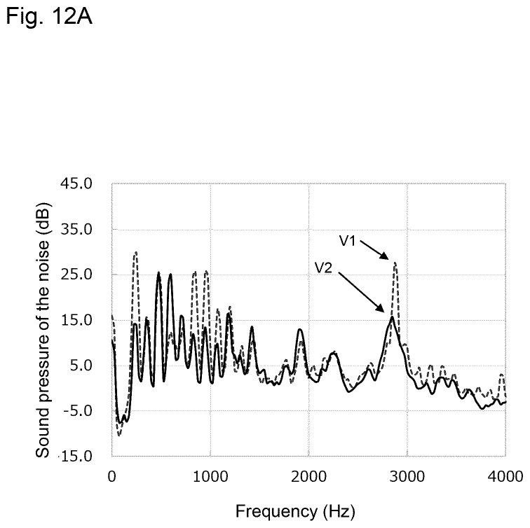

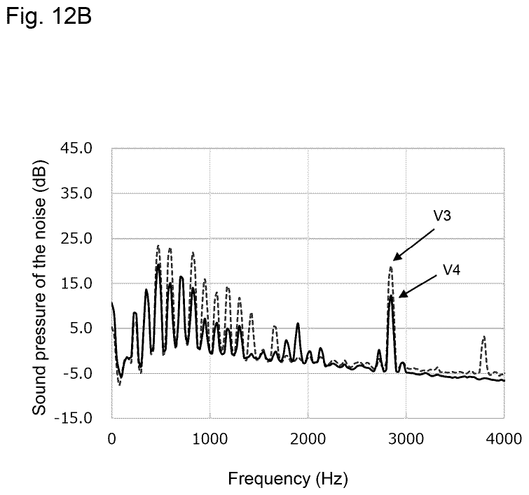

To verify the effect of suppressing the noise by the rotating body attachment structures according to the embodiment of the present disclosure, noise measurement during operation was conducted on a projection-type image display device including a phosphor wheel and a color wheel. Hereunder, description will be given for conducting the noise measurement on the projection-type image display device according to embodiment of the present disclosure with reference to FIGS. 11 to 12B.

### (Noise Measurement of Projection-Type Image Display Device)

FIG. 11 is a schematic view illustrating a noise measurement layout of a projection-type image display device 100. This measurement was conducted in accordance with the measurement standard ISO 7779 for airborne noise output from information technology and telecommunications equipment.

The projection-type image display device 100 to be measured includes the light source device 30 including the phosphor wheel 350 and the color wheel 370 illustrated in FIG. 2. The phosphor wheel included in the light source device 30 had the basic configuration illustrated in FIG. 3 and had a diameter of about 73 mm, and the color wheel had the basic configuration illustrated in FIG. 4 and had a diameter of about 80 mm. Noise of the projection-type image display device 100 during operation was measured in a case where each of the phosphor wheel and the color wheel was attached to a support body of a rotating body in direct contact with conventional screw parts, and in a case where each of the phosphor wheel and the color wheel was attached to the support body of the rotating body by using the rotating body attachment structures 500A according to the first example of the present disclosure. Elastic members of the rotating body attachment structures 500A were constituted using an ACM rubber bush.

Noise during the operation of the projection-type image display device 100 was measured using a measuring instrument conforming to IEC 60651 or IEC 60684-1. During the measurement, the projection-type image display device 100 was disposed at the center of the measuring stand defined in Appendix A of ISO 7779, and airborne noise signals output from the projection-type image display device 100 were received by a receiver 80 including a microphone. The receiver 80 was disposed toward the projection-type image display device 100, away from the projection-type image display device 100 by a horizontal distance M of about 1 m and a height H of about 0.75 m at a downward inclination angle θ of about 30 degrees from the horizontal plane.

The measurement was performed in four directions of front, rear, left, and right of the projection-type image display device 100. Using measured values L1, L2, L3, and L4 that were obtained in the four directions and subjected to correction for background noise, values calculated by Formula (1) below were defined as a noise sound pressure value.

$${L}_{p} = 10 log [ \frac{1}{4} ( 10 \text{?} + 10 \text{?} + 10 \text{?} + 10 \text{?} ) ] \qquad ( 1 )$$

$$\text{?} \text{indicates text missing or illegible when filed}$$

FIGS. 12A and 12B illustrate analysis results of noise sound pressure values calculated by measurement for each of the phosphor wheel and the color wheel. FIG. 12A is a graph illustrating measurement results of noise caused by vibration during rotation of the phosphor wheel, and FIG. 12B is a graph illustrating measurement results of noise caused by vibration during rotation of the color wheel. In FIGS. 12A and 12B, broken lines indicate sound pressure of the noise in the case where the phosphor wheel or the color wheel was attached to the support body in direct contact with conventional screw parts, and solid lines indicate sound pressure of the noise in the case where the phosphor wheel or the color wheel was attached to the support body by using the rotating body attachment structures 500A according to the first example of the present disclosure.

As illustrated in FIG. 12A, when the phosphor wheel was attached to the support body in direct contact with the screw parts, by using conventional attachment structures, a peak value V1 of the sound pressure of the noise around a frequency of 3000 Hz was about 27.5 dB. On the other hand, when the phosphor wheel was attached to the support body via the elastic member without being in direct contact with the screw parts, by using the rotating body attachment structures of the present disclosure, a peak value V2 of the sound pressure of the noise around the frequency of 3000 Hz was about 15.5 dB. As compared with the conventional attachment structure, use of the rotating body attachment structure of the present disclosure made it possible to reduce the noise around the frequency of 3000 Hz caused by the vibration of the phosphor wheel, to about 56.4% of the conventional attachment structure.

Next, as illustrated in FIG. 12B, when the color wheel was attached to the support body in direct contact with the screw parts, by using the conventional attachment structures, a peak value V3 of the sound pressure of the noise around the frequency of 3000 Hz was about 19.0 dB. On the other hand, when the color wheel was attached to the support body via the elastic member without being in direct contact with the screw parts, by using the rotating body attachment structures of the present disclosure, a peak value V4 of the sound pressure of the noise around the frequency of 3000 Hz was about 12.5 dB. As compared with the conventional attachment structure, use of the rotating body attachment structure of the present disclosure made it possible to reduce the noise around the frequency of 3000 Hz caused by the vibration of the color wheel, to about 65.8% of the conventional attachment structure.

As described above, it has been revealed that the noise due to the vibration during the rotation can be suppressed by attaching the phosphor wheel or the color wheel using the rotating body attachment structure of the present disclosure.

The rotating body attachment structure of the present disclosure has been described above while the phosphor wheel and the color wheel are taking as examples of the rotating body, and verification was conducted mainly on the suppression of the noise around the frequency of 3000 Hz; however, the present disclosure is not limited thereto. The rotating body attachment structure of the present disclosure is not limited to being applied to the phosphor wheel and the color wheel, and further, is not limited to being applied to the optical rotating body. The rotating body attachment structure of the present disclosure can generally be utilized for attaching various rotating bodies in rotating apparatuses, such as an electric fan, a stirrer, and a fan. Further, it is possible to suppress noise at different frequencies occurring caused by vibration during rotation of various rotating bodies by configuring the rotating body attachment structure of the present disclosure with an elastic member suitable for operating environments of the various rotating bodies.

As described above, the accompanying drawings and the detailed description have been provided to describe an exemplary embodiment of the technology in the present disclosure. The components described in the accompanying drawings and the detailed description may include not only components essential for solving the problem but also components inessential for solving the problem, in order to exemplify the above technology. Thus, it should not be immediately recognized that those inessential components are essential on the ground of the fact that those inessential components are described in the accompanying drawings and the detailed description.

The present disclosure has been fully described in connection with preferred embodiments with reference to the accompanying drawings; however, various modifications can be made within the scope recited in the claims. Embodiments obtained by appropriately combining such modifications and technical means that are disclosed in different embodiments are also included in the technical scope of the present disclosure.

The present disclosure is applicable to structures to which various rotating bodies are attached, and, for example, is applicable to devices using optical rotating bodies, such as a phosphor wheel and a color wheel.

What is claimed is:

1. A rotating body attachment structure for attaching a rotating body having a hole formed in an attachment surface to a support body having an attachment hole extending through the support body in an axial direction of a rotation axis of the rotating body, the rotating body attachment structure comprising:
an elastic member having a through-hole in the axial direction and configured to be fitted into the attachment hole; and
a fixing member including a first portion configured to be inserted into the through-hole in contact with the elastic member, and a front portion configured to be inserted into and fixed in the hole.

2. The rotating body attachment structure according to claim 1, wherein
the fixing member further includes a rear portion exposed from the through-hole on an opposite side of the attachment surface,
the rear portion includes a first wall surface intersecting with the axial direction, and
in a state that the front portion is fixed in the hole, the elastic member is compressed between the attachment surface and the first wall surface.

3. The rotating body attachment structure according to claim 2, wherein
the first portion includes a second wall surface intersecting with the axial direction at an end adjacent to the front portion, and
in a state that the front portion is fixed in the hole, the second wall surface is in contact with the attachment surface.

4. The rotating body attachment structure according to claim 1, wherein
the hole is a screw hole,
the fixing member includes a sleeve and a screw member having a portion inserted into the sleeve, and
the sleeve is disposed in contact with the elastic member.

5. The rotating body attachment structure according to claim 4, wherein
the sleeve includes the first portion, and a second portion exposed from the through-hole on the opposite side of the attachment surface,
the screw member includes the front portion, and a head portion exposed from the sleeve on the opposite side of the attachment surface, and
in a state that the front portion of the screw member is screwed into the screw hole, the second portion of the sleeve defines a first wall surface intersecting with the axial direction, and the elastic member is compressed between the attachment surface and the first wall surface.

6. The rotating body attachment structure according to claim 4, wherein
the sleeve defines the first portion,
the screw member includes the front portion, and a head portion exposed from the sleeve on the opposite side of the attachment surface, and
in a state that the front portion of the screw member is screwed into the screw hole, the head portion defines a first wall surface intersecting with the axial direction, and the elastic member is compressed between the attachment surface and the first wall surface.

7. The rotating body attachment structure according to claim 5, wherein,
in a state that the front portion is screwed into the screw hole, the sleeve is in contact with the attachment surface at the first portion, and in contact with the head portion at the second portion.

8. The rotating body attachment structure according to claim 2, wherein
the hole is a screw hole,
the fixing member is integrally formed,
the front portion includes screw threads,
the first portion has a first cross section that is larger than the front portion in a direction intersecting with the axial direction, and
the first wall surface is larger than the first cross section.

9. The rotating body attachment structure according to claim 8, wherein,
in a state that the front portion is screwed into the screw hole, the first portion is in contact with the attachment surface at an end adjacent to the front portion.

10. The rotating body attachment structure according to claim 1, wherein
the elastic member includes a recessed section that is formed in an outer peripheral surface in a circumferential direction, and
a support member around the attachment hole is fitted into the recessed section.

11. The rotating body attachment structure according to claim 1, wherein the fixing member is made of a material containing metal.

12. The rotating body attachment structure according to claim 1, wherein the elastic member is made of a material containing ACM rubber.

13. The rotating body attachment structure according to claim 1, wherein,
the rotating body constitutes a phosphor wheel configured to convert incident light into light of a different wavelength, or a color wheel configured to transmits incident light in a plurality of color bands.

14. A light source device comprising:
a light source configured to output incident light; and
a phosphor wheel that is attached by using the rotating body attachment structure according to claim 1, and configured to convert the incident light into light of a different wavelength, or a color wheel that is attached by using the rotating body attachment structure according to claim 1, and configured to transmit the incident light in a plurality of color bands.

15. A projection-type image display device comprising:
the light source device according to claim 14;
a projection light generator configured to generates projection light based on an image signal;
a light-guide optical system configured to guide illumination light output from the light source device to the projection light generator; and
a projection optical system configured to enlarge and project the projection light from the projection light generator to display an image.
